(19) United States
(12) Patent Application Publication
(10) Pub. No.: US 2025/0175416 A1
(43) Pub. Date: May 29, 2025

(54) SEGMENT ROUTING USING UNIQUE PATHS

(71) Applicant: Cisco Technology, Inc., San Jose, CA (US)

(72) Inventors: Radu Teodor Valceanu, Kanata (CA); Darren Russell Dukes, Ottawa (CA); David Toscano, Nepean (CA)

(21) Appl. No.: 18/523,459

(22) Filed: Nov. 29, 2023

(51) Int. Cl. H04L 45/00; H04L 43/0829; H04L 45/12

(52) U.S. Cl. CPC H04L 45/34; H04L 43/0835; H04L 45/123

(57) ABSTRACT

Discussed are systems, methods and computer readable media that use a segment routing system and compute a path for network traffic based on segment routing policies. Based on these computations, the system is able to determine a path, and if the path is unique. When the path is unique it is stored in a path database which includes the unique paths available to the segment routing system. Based on the path database and segment routing polices, the system will compute a best path from the available unique paths for the network traffic based on measured and predicted performance metrics of the unique paths.

### TECHNICAL FIELD

The present disclosure relates to identifying unique paths within a network, allowing for the dynamic assessment of each unique path to facilitate communication. During operation, multiple different policies can lead to the independent selection of the same path without the system understanding if that path is unique. The present disclosure includes the separation of policy decisions from path determination so that the system is able to independently assess paths chosen by each policy.

### BACKGROUND

The communications industry is rapidly changing to adjust to emerging technologies and ever-increasing customer demand. Customer demand for new applications and increased performance of existing applications is driving communications network and system providers to employ networks and systems having greater speed and capacity (e.g., greater bandwidth and performance). In trying to achieve these goals, a common approach taken by many communications providers is to use packet-switching technology. Packets are typically forwarded in a network based on one or more values representing network nodes or paths.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an exemplary environment in which segment routing communications can take place, which can be for example any computing device that can implement components of the system;

FIG. 2 illustrates a segment routing network operating according to one embodiment;

FIG. 3 illustrates different Segment Routing (SR) packet formats according to one embodiment;

FIG. 4 illustrates an exemplary environment in which a policy database and a path database determine the best unique path for transmitting packets to a destination;

FIG. 5 illustrates an example process for using a segment routing policy and a path database to determine the best path to use for transmitting packets to a destination;

FIG. 6 illustrates a computing system architecture including various components in electrical communication with each other using a connection in accordance with some embodiments;

FIG. 7 illustrates an example network device suitable for performing switching, routing, and other networking operations in accordance with some embodiments.

### DETAILED DESCRIPTION

Certain aspects of this disclosure are provided below. Some of these aspects may be applied independently, and some may be applied in combination, as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

### Overview

The present technology allows for the identification of unique paths along with the separation of the path determination from the policy determinations. By separating the path determination and the policy determinations the system reduces cyclic degradation and increases scale of performance measurement for segment routing (SR) paths. This also allows for the separate calculation and monitoring of health scores and performance metrics to influence forwarding and path compute decisions. The system operates using a process that identifies unique paths for transmission. Initially, the system computes a path for network traffic based on a segment routing policy and then determines if the path is unique. When the path is unique the unique path can be stored in a path database with the other identified unique paths for transmission. The system is then able to compute the best path from the unique paths available for network traffic based, the calculations take place based on predicted performance metrics and health scores of the available unique paths. Based on the identified best path for transmission, the system then transmits the designated packets to the destination.

The present technology solves problems associated with a system that combines the path determinations with the policy determinations. When the path and policy determinations are made concurrently the system can often find the same path even though that path has been found by a previous policy. Under these circumstances, the system tracks and calculates the performance metrics and health scores multiple times for the same path. Further, the system is often sending multiple probes over the same paths based on the identification from different policies. When these calculations, measurements, and probes are repeated over the same paths, the system wastes resources in both the network and the router. With a busy network, the wasted resources can overwhelm the system and cause delays and system failures. By removing these redundant processes, the system is better able to handle increased traffic environments and reduce wasted processing and networking energy consumption.

The present technology solves problems associated with the prediction mechanism for path health. By storing the paths in the path database and then measuring the health scores and performance metrics of each of the unique paths the system has access to information regarding the current state of each path. The system is then able to undertake a prediction calculation based on the measured path data, which allows the system to determine if the paths are going to be use for transmission of packets for the specific policy. If the paths are unstable or consistently dropping packets, amongst other problems, the system is able to update the information associated with that path in the path database and avoid using it while it is unstable. The system is also able to continue to monitor and measure the unique paths allowing the system to update the performance metrics and health scores of each unique path which would allow a policy to use a path when the health scores or performance metrics improve, even if that path had been previously avoided.

The present technology solves problems associated with the monitoring and calculation of path health for each unique path. The monitoring system can calculate path health and predictions to influence forwarding decisions. This allows the system to provide a synthesized per-path health score that includes a measured state of the current path as well as a predictive state of the current path state. Using these measured and calculated values associated with a unique path allows for the appropriate determinations as to which paths are best now and will be the best in the future. This allows the system to better understand and predict which paths to use for transmission. This also allows the system to dynamically update individual paths when changes are measured or predicted for that path. Because of the design of the system, with the storage of the unique paths separate from the routing decisions, the system is able to more efficiently identify and predict paths for transmission, allowing for the better processing and overall operation of the system.

The present technology solves problems associated with the predictions and proactive use of measured and predicted health scores and performance metrics. After calculation and storage of the performance metrics and health scores, the distribution of those performance metrics and health scores, both measured and predicted, can be shared with other systems and allows for the better functioning of the overall network that is attached the system. The distribution of the calculated and predicted health scores and performance metrics allow for better path compute decisions and retroactive use of this data for archiving paths. Various distribution mechanisms are possible, one such method includes extensions to BGP LS via new path attributes that encodes a path as a source, endpoint, and one-way hash of a segment list with measured and predicted health sub tlvs. Using these distribution parameters allows for the better overall operation of the system by using and sharing the measured and predicted health scores and performance metrics.

### IPv6 Environment

In an IPv6 environment, nodes (e.g., source nodes, midpoint nodes, sink nodes, etc.) can be reached via an IPv6 address or prefix. The IPv6 packets can include an IPv6 header which identifies a source and destination segments for the packets, and may include functions to be applied by one or more segments in the IPv6 header. In some cases, data stored in nodes can also be assigned an IPv6 or prefix, which can be used to identify and access that data. For example, one or more nodes storing a block of data can be assigned an IPv6 prefix, and each instance of the block of data can be assigned an IPv6 address within the IPv6 prefix. The IPv6 address of the block of data can be used to access the block of data. This scheme can ensure that requests for data addressed to an IPv6 address of the data are routed to the appropriate node(s) containing the data and associated with the IPv6 prefix.

### Segment Routing (SR)

SR is a source-routing paradigm which allows a packet to follow a predefined path, defined by a list of segments or SR list. The approaches herein leverage SR and IPv6 techniques for accurate and efficient storage operation load balancing and latency reduction.

SR and IPv6 can be leveraged together by implementing an IPv6 header and a SR header (SRH) in a packet. For example, in some cases, an IPv6 extension header can be implemented to identify a list of segments for SR and a counter SegmentsLeft, indicating the number of remaining segments to be processed until the final destination of the packet is reached. In an SR packet, the IPv6 destination address can be overwritten with the address of the next segment in the SR list. This way, the packet can go through SR-unaware routers or nodes until reaching the next intended SR segment or hop. Upon receipt of an SR packet, an SR-aware router or node will set the destination address to the address of the next segment in the SR list, and decrease the Segments Left (SL) counter. When the packet reaches the last SR hop or segment in the SR list, the final destination of the packet is copied to the IPv6 destination address field. Depending on the value of a flag in the header, the SRH can be stripped by the last SR hop or segment so the destination receives a vanilla IPv6 packet.

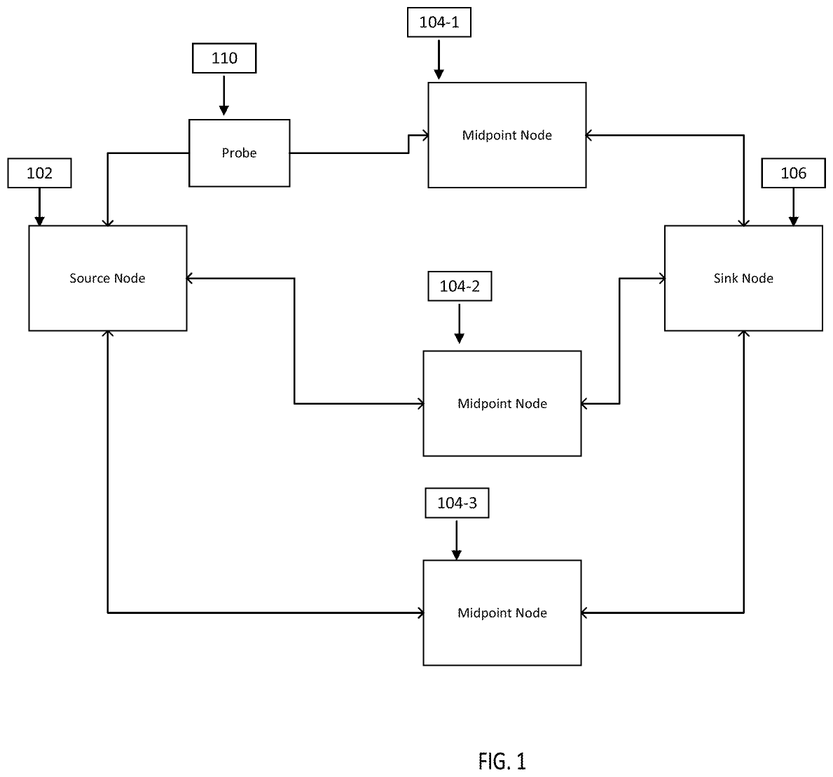

FIG. 1 shows an illustrative example of an environment 100 which includes a plurality of nodes that are interconnected through an SRv6 overlay which routes network traffic between these nodes using SRv6. In this example, node 102 represents a source node or ingress point within the network, nodes 104-1-104-N (collectively “104” hereinafter) represent a set of midpoint nodes within the network, and nodes 106-1-106-N (collectively “106” hereinafter) represent a set of sink nodes or egress points within the network.

In an embodiment, a controller can interact with node 102 to collect topology information, perform path computation, propagate routes across the nodes 102-106, propagate segment routing identifiers (SIDs) and policies across the nodes 102-106, perform traffic engineering, and the like. The controller can be, for example, a Border Gateway Protocol (BGP) controller with a path computation engine. The controller can reside within the network illustrated in FIG. 1 or any other network. In an embodiment, the controller can collect topology information from the nodes 102-106 and propagate forwarding rules and SR IDs (e.g., SIDs) and policies using one or more protocols, such as Open Shortest Path First (OSPF), Intermediate System to Intermediate System (IS-IS), BGP Link-State (BGP-LS), BGP Traffic Engineering (BGP-TE), and the like. For example, the controller can collect topology information for nodes 102-106 using the BGP-LS protocol. The controller can also include a path computation engine (PCE) for computing the best paths between the nodes 102-106. The controller can use the collected topology information to perform the path computation. The controller can then use the BGP-TE to populate reachability information, such as forwarding rules and SR IDs and policies, on the nodes 102-106.

The nodes 102-106 can include a control plane that interfaces with BGP-LS and BGP-TE to receive the forwarding rules and SR IDs policies from the controller. The nodes 102-106 can also include a data plane that processes IPv4 and/or IPv6 packets and is able to encapsulate/decapsulate IPv4 or IPv6 packets into SRv6 packets. Moreover, the nodes 102-106 can include BGP agents, such as GoBGP agents, to interact with the controller or any BGP peers. In some cases, the nodes 102-106 can also include an active measurement system based on IP SLA (Internet Protocol Service Level Agreement) to collect network performance information and monitor quality-of-service (QoS) between the nodes 102-106. The nodes 102-106 are SRv6 capable and can route traffic over the SRv6 overlay using SRv6.

In an embodiment, the controller requests the source node 102 to generate a MPLS path tracing probe message 110 that may be used to trace the path of the probe message 110 through the network from an ingress point (e.g., source node 102) to an egress point (e.g., a sink node 106) through one or more midpoint node(s) 104. The controller may provide, to the source node 102, the address of the sink node 106 that is to serve as the egress point for the probe message, along with a segment-list that indicates the explicit path that is to be traversed from the source node 102 to the designated sink node 106. For example, as illustrated in FIG. 1, the path may have the probe message 110 traverse the midpoint node 104 towards the sink node 106.

The probe message 110 may be generated using a MPLS path tracing (PT) packet format. For instance, the probe message 110 may include a MPLS stack header that includes an SR-MPLS label stack or MPLS transport label, a “Timestamp, Encapsulate, and Forward” (TEF) network programming or special purpose label, an entropy label indicator (ELI), a structured entropy label (SEL), and a generic associated channel (G-ACH) header. The SR-MPLS label stack or MPLS transport label may carry MPLS to enable transport of the probe message 110 over a best-effort path, Internet Gateway Protocol (IGP) path, or through a SR traffic engineering (SR-TE) path. The TEF network programming label may trigger the path tracing behavior at the designated sink node 106. In an embodiment, the TEF network programming label can be encoded before the ELI and SEL labels to ensure that the ELI and SEL labels are not removed on the penultimate hop node along the path. In some instances, the TEF label can be encoded after the ELI and SEL labels as a bottom-of-stack (BoS) label. In some instances, another label (e.g., a Virtual Private Network (VPN) label) may be added at the bottom of the stack label. The probe message 110 may also include a synthetic IP or customer data packet that includes other data, such as customer data and the like.

The ELI label may be a standard MPLS special purpose label (e.g., having a value of 4-6, 8-12, etc.) or a general network programming label. The ELI label may carry a specific value (e.g., label value=7). The ELI label may be used to indicate the presence of the SEL within the probe message 110, which is required to be the next label after the ELI label. The SEL may have a general format that may be used to trigger the path tracing behavior at each of the midpoint nodes 104 along the path. The SEL may include a slice identifier (SLID) that is used to encode the network slice ID corresponding to the network slice in the MPLS domain. Further, the SEL may include an entropy field, that is used to encode the entropy of the data packet (e.g., probe message 110). The SEL may further include a Traffic Class (TC) field and a BoS field, where the BoS field may be set if the SEL is the BoS label of the probe message 110. The SEL, in an embodiment, includes a set of entropy label control (ELC) bits that carry per-packet control bits. The ELC may include a flag defined as a SLID presence indicator (SPI) that indicates that the SEL carries the SLID as well as the entropy value. In some instances, the ELC may use bits from the 3-bit TC field or 20-bit label fields for this purpose. The probe packets may carry more than one SEL in the MPLS header label stack. For instance, a midpoint node 104 may copy the ELC field from the received SEL to the new SEL when inserting the new SEL in the MPLS header label stack. A midpoint node 104 may scan the entire label stack to identify the PTI if more than one SEL is present in the label stack.

In an embodiment, the SEL includes a path tracing indicator (PTI) within the ELC that can be used to trigger the path tracing behavior at the midpoint node(s) 104. The PTI may be used to indicate the presence of path tracing Type-Length-Values (TLVs) within the probe message 110. The PTI may cause the midpoint node(s) 104 receiving the probe message 110 to record their midpoint compressed data (MCD) in the MCD stack of the probe message 110, as described in greater detail herein.

The G-ACH header may be used in MPLS to carry Operations, Administration, and Maintenance (OAM) data. The G-ACH header may indicate, to the midpoint node(s) 104 receiving the probe message 110, that the probe message 110 is a control data packet, which may prevent the midpoint node(s) 104 from parsing the data after the label stack as an IPv4 or an IPv6 data packet. The G-ACH header may also include a version field, which may denote the G-ACH version used. Through the G-ACH header, a new channel type may be defined for path tracing. For instance, the G-ACH header may indicate a format of the message that follows the G-ACH header. This format may be defined as the MCD stack and the source node TLV. Further, the G-ACH header may be modified such that a set of reserved bits within the state are redefined to indicate the size of the MCD stack. It should be noted that the use of a G-ACH header is optional and the MCD stack may be provided after the SEL without any G-ACH header.

The MPLS stack header may further a path tracing indicator that can cause the node to shift the previously recorded path tracing data within the MCD stack to generate capacity for the new path tracing data of the node. This new path tracing data may then be inserted into the MCD stack at the newly generated capacity created by shifting the previously recorded path tracing data by a pre-defined number of bits. This set of shifting instructions does not require extending the packet buffer of the probe message 110. Instead, the set of shifting instructions may instruct the node to move the pre-existing data from one offset to another within the MCD stack.

In an embodiment, the source node 102 can introduce its path tracing data within the probe message 110. For instance, the source node 102 can include a SRH PT-TLV that is used to carry the path tracing data of the source node 102. The source node data may include an outgoing interface identifier, an outgoing interface load, and a full transmit timestamp. In some instances, the source node 102 also encodes in the SRH PT-TLV the probe message session identifier and the probe message sequence number. The probe message session identifier may be used to co-relate probe messages of the same session. The probe message sequence number may be used to detect any probe message losses. In some instances, the source node 102 may encode additional information to the SRH PT-TLV. Recording of the data to the SRH PT-TLV may be performed using a network processing unit (NPU) or CPU. The source node may also include its node (IPv4 or IPv6) address in the TLV. The node address of the source node is used by the collector to identify the source of the probe packet.

In path tracing, each midpoint node 104 records its path tracing data (referred to herein as “MCD”). The MCD stack may be configured to allocate sufficient capacity to accommodate the MCD of any midpoint node(s) 104 along the path. In some instances, the MCD of a node is three bytes (24 bits), which are used to include a short interface identifier (e.g., 12 bits), a short timestamp (e.g., 8 bits), and an interface load (e.g., 4 bits). It should be noted that different MCD sizes may be supported. Further, the MCD can include more information in addition to the short interface identifier, the short timestamp, and the interface load. For instance, the 8-bit short timestamp may include a part of the 64-bit Precision Time Protocol v2 (PTPv2) timestamp and may include nanosecond field bits from 28 to 21. The MCD stack may be carried after the SEL without the G-ACH header. Further, the MCD stack may be carried after the BoS label (which may be different from the SEL) without the G-ACH header. Setting the first nibble of the G-ACH header to 0001b allows for avoidance of incorrect hashing for the ECMP on midpoint nodes 104. When the entropy label is used for hashing by the midpoint nodes 104, the G-ACH header need not be added in the packet. The MCD stack may be carried after the BoS label (which may be different from the SEL) with the G-ACH header. As illustrated in FIG. 1, the source node 102 may introduce its path tracing data at the top of the MCD stack, leaving a set of empty path tracing data bits after the path tracing data. This set of empty path tracing data bits may be utilized by the midpoint node(s) along the path and the sink node 106 to provide their path tracing data.

Once the source node 102 has generated the probe message 110 and has recorded its data within the source node TLV stack, the source node 102 may transmit the probe message 110 to the next hop on the path. As noted above, the controller may provide, to the source node 102, the address of the sink node 106 that is to serve as the egress point for the probe message 110, along with a segment-list that indicates the explicit path that is to be traversed from the source node 102 to the designated sink node 106. From this segment-list, the source node 102 may identify the next hop, which, as illustrated in FIG. 1, may be the midpoint node 104-1.

In response to receiving the probe message 110 from the source node 102, the midpoint node 104-1 may perform a MPLS lookup on the topmost label of the probe message 110 to determine the next hop for the probe message 110 (in this case, sink node 106). For instance, the midpoint node 104-1 may evaluate the segment-list in the probe message 110 to identify the next hop for the probe message 110 once the midpoint node 104-1 has added its path tracing data to the probe message 110. As illustrated in FIG. 1, the next hop for the probe message 110 may be the sink node 106. However, it should be noted that there may be additional midpoint nodes 104 along the path prior to delivery of the probe message 110 to the sink node 106. The midpoint node 104-1, however, may only identify the next hop to ensure that the probe message 110 is transmitted to the proper destination.

In an embodiment, the midpoint node 104-1 may scan the label stack of the probe message 110 to identify the SEL for evaluation. The midpoint node 104-1 may evaluate the ELC field of the SEL to determine whether the PTI flag has been set. As noted above, the PTI flag can be used to trigger the path tracing behavior at the midpoint nodes 104-1. The PTI flag may be used to indicate the presence of path tracing Type-Length-Values (TLVs) within the probe message 110. The path tracing TLVs may cause the midpoint node 104-1 to record its midpoint compressed data (MCD) in the MCD stack of the probe message 110. For instance, the midpoint node 104-1 may compute its MCD and search for the BoS label. The midpoint node 104-1, upon locating the BoS label, may locate the MCD stack and record its MCD (e.g., path tracing data) in the MCD stack. The MCD of the midpoint node 104-1 may include the timestamp, interface identifier, and interface load of the midpoint node 104-1.

In an embodiment, the midpoint node 104-1 uses a shift and stamp process to record its path tracing data to the MCD stack. As noted above, the path tracing instruction included in the MPLS stack header of the probe message 110 can include a set of instructions that, when parsed by a node, can cause the node to shift the previously recorded path tracing data within the MCD stack to generate capacity for the new path tracing data of the node. Accordingly, the midpoint node 104-1 may shift any previously recorded path tracing data (e.g., MCD) from other midpoint nodes by a number of bytes equal to the MCD size such that this number of bytes is available at the top of the MCD stack for insertion of the midpoint node's MCD. Thus, every midpoint node 104 along the path 112 may record its MCD to the same position within the MCD stack after shifting the previously recorded MCD from other midpoint nodes by the amount of bytes required for the new MCD. In an alternative example, the midpoint node 104-1 may append its MCD by receiving the offset value in the MCD header, which the midpoint node 104-1 may use to write in the MCD stack. The midpoint node 104-1 may update the offset value after writing the MCD in the MCD stack and, subsequently, forward the probe message 110. Optionally, the MCD may be appended at the top of the stack or at the bottom of the stack, making the recordation of the MCD implementation dependent.

Once the midpoint node 104-1 (or a penultimate node along the path) records its MCD into the MCD stack, the midpoint node 104-1 may transmit the probe message 110 to the sink node 106 designated in the topmost label of the probe message 110. In some instances, in the event of ECMP, the midpoint node 104-1 may use the entropy field of the SEL to select the next hop for the probe message 110.

In an embodiment, when the probe message 110 is received at the sink node 106, the sink node 106 evaluates the probe message 110 to determine whether the probe message 110 includes the TEF network programming label. As noted above, the TEF network programming label may trigger the path tracing behavior at the sink node 106. The TEF network programming label may be encoded before the ELI and SEL labels to ensure that the ELI and SEL labels are not removed on the penultimate hop node along the path. In some instances, the TEF label can be encoded after the ELI and SEL labels as a bottom-of-stack (BoS) label. In some instances, another label (such as a VPN label) may be encoded as the BoS label.

In an embodiment, the sink node 106 is configured with an SR policy (with TEF behavior) that encapsulates received probe messages 110 in SRv6 encapsulation and forwards these to a collector. The SRv6 encapsulation may comprise an outer IPv6 header, an SR header (SRH), and an SRH Path Tracing Type-Length-Value (SRH PT-TLV). The SRH PT-TLV may be used to carry the sink node information. The MPLS label stack and the path tracing data (e.g., MCD and source path tracing data) in the data packet that is to be transmitted to the collector may include similar elements to that of the probe message 110, namely the MPLS stack with PT instruction and the path tracing data of the various nodes along the path. In an embodiment, the TEF network programming label is used as a binding SID to trigger the SR policy encapsulation of the probe message 110.

In an embodiment, the sink node 106 can support different encapsulation behaviors for both probe messages 110 and customer data packets. If the received data packet is a probe message 110, the sink node 106 may encapsulate the entire probe message 110 using SRv6 encapsulation, resulting in a data packet that includes the SRv6 encapsulation, the MPLS label stack, the path tracing data, and a synthetic IP packet. Alternatively, if the received data packet is a customer data packet, the sink node 106 may extract the path tracing data from the customer data packet and may encapsulate this data in SRv6 encapsulation. The SRv6 encapsulation, along with the MPLS label stack and the path tracing data from the customer data packet may be transmitted to the collector. Further, the customer data packet may be forwarded to its intended destination after the MPLS stack and path tracing header are removed from the customer data packet.

As used herein, a node is a device in a network; a router (also referred to herein as a packet switching device) is a node that forwards received packets not explicitly addressed to itself (e.g., an L2 or L3 packet switching device); and a host is any node that is not a router.

The term “route” is used to refer to a fully or partially expanded prefix (e.g., 10.0.0.1, 10.0.*.*, BGP Network Layer Reachability Information (NLRI), EVPN NLRI), which is different than a “path” through the network which refers to a next hop (e.g., next router) or complete path (e.g., traverse router A then router B, and so on). Also, the use of the term “prefix” without a qualifier herein refers to a fully or partially expanded prefix.

Embodiments described herein include various elements and limitations, with no one element or limitation contemplated as being a critical element or limitation. Each of the claims individually recites an aspect of the embodiment in its entirety. Moreover, some embodiments described may include, but are not limited to, inter alia, systems, networks, integrated circuit chips, embedded processors, ASICs, methods, and computer-readable media containing instructions. One or multiple systems, devices, components, etc., may comprise one or more embodiments, which may include some elements or limitations of a claim being performed by the same or different systems, devices, components, etc. A processing element may be a general processor, task-specific processor, a core of one or more processors, or other co-located, resource-sharing implementation for performing the corresponding processing. The embodiments described hereinafter embody various aspects and configurations, with the figures illustrating exemplary and non-limiting configurations. Computer-readable media and means for performing methods and processing block operations (e.g., a processor and memory or other apparatus configured to perform such operations) are disclosed and are in keeping with the extensible scope of the embodiments. The term “apparatus” is used consistently herein with its common definition of an appliance or device.

The steps, connections, and processing of signals and information illustrated in the figures, including, but not limited to, any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of read the value, process said read value—the value must be obtained prior to processing it, although some of the associated processing may be performed prior to, concurrently with, and/or after the read operation). Also, nothing described or referenced in this document is admitted as prior art to this application unless explicitly so stated.

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment must include, although an embodiment typically may include all these features, elements and/or limitations. In addition, the terms “first,” “second,” etc., as well as “particular” and “specific” are typically used herein to denote different units (e.g., a first widget or operation, a second widget or operation, a particular widget or operation, a specific widget or operation). The use of these terms herein does not necessarily connote an ordering such as one unit, operation or event occurring or coming before another or another characterization, but rather provides a mechanism to distinguish between elements units. Moreover, the phrases “based on x” and “in response to x” are used to indicate a minimum set of items “x” from which something is derived or caused, wherein “x” is extensible and does not necessarily describe a complete list of items on which the operation is performed, etc. Additionally, the phrase “coupled to” is used to indicate some level of direct or indirect connection between two elements or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive or open-ended and does not exclude additional, unrecited elements or method steps. Finally, the term “particular machine,” when recited in a method claim for performing steps, refers to a particular machine within the 35 USC § 101 machine statutory class.

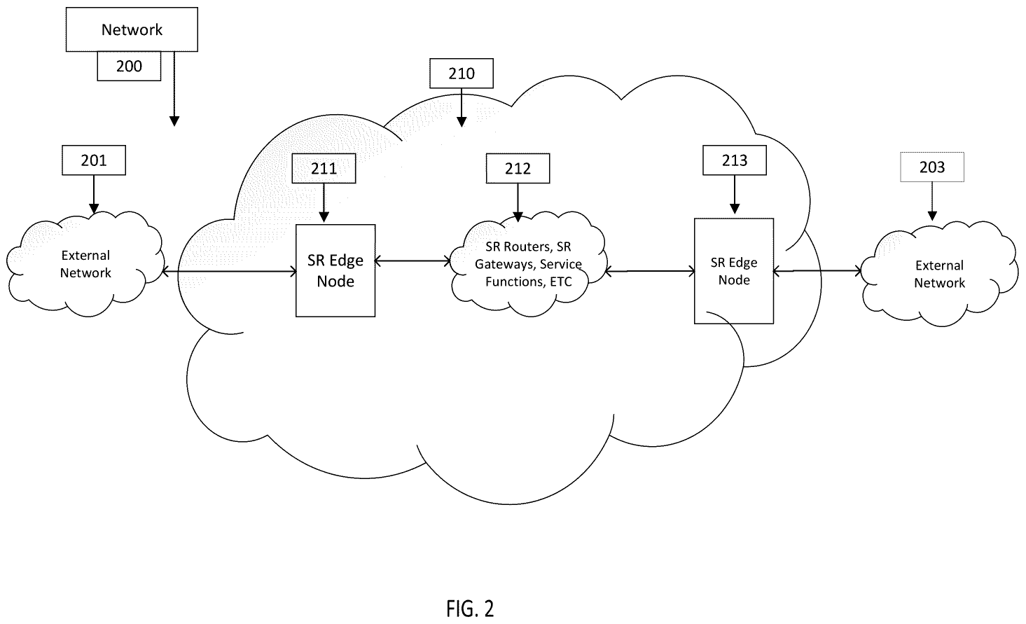

FIG. 2 illustrates network 200 operating according to one embodiment. As shown, network 200 includes networks 201 and 203 (which are the same network in one embodiment) external to network 210, which includes edge nodes (e.g., SRv6 and/or MPLS) 211 and 213 and a network 212 of nodes (e.g., routers, hosts, gateways, and service functions) some, none, or all of which may be SR-capable nodes. In response to receiving a native packet, an SR edge node 211, 213 identifies an SR policy (e.g., list of one or more segments) through or to which to forward an SR packet encapsulating the native packet. These policies can change in response to network conditions, network programming, route advertisements, etc. SR edge nodes 211 and 213 also decapsulate native packets from SR packets and forward the native packets into networks 201 and 203.

For example, one embodiment includes: a particular route associated with a particular Internet Protocol Version 6 (IPv6) Segment Routing (SRv6) Segment Identifier (SID), with the SID including a locator of a particular router, with the particular SID including a routable prefix to the particular router; receiving, by the particular router, a particular packet including the particular SID; and in response to said received particular packet including the particular SID, the particular router performing the particular end function on the particular packet. In one embodiment, the particular packet includes a Segment Routing Header (SRH) including the particular SID as the currently active SID. In one embodiment, the routing protocol is Border Gateway Protocol, and the particular route advertising message advertises a BGP route type 1, 2, 3, or 5, and associated with a particular SRv6-VPN Type Length Value (TLV) including the particular SID. In one embodiment, the particular route advertising message includes advertising the particular route being associated with one or more BGP Multiprotocol Label Switching-based (MPLS-based) labels to use in an MPLS packet to invoke corresponding BGP MPLS-based EVPN functionality on a corresponding MPLS packet by the particular router.

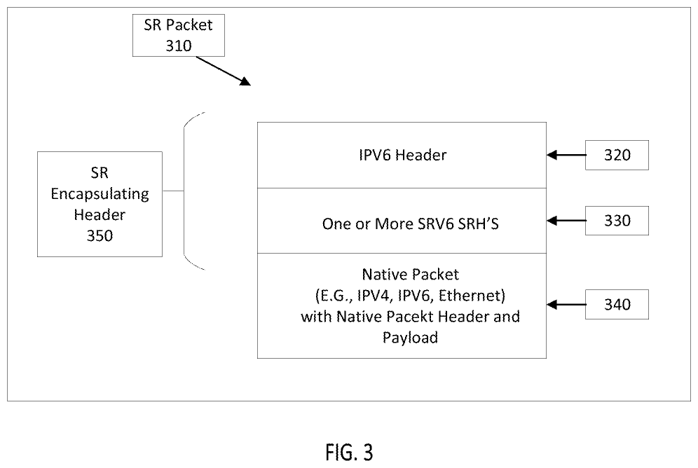

FIG. 3 illustrates a Segment Routing (SR) packet 310 according to one embodiment. As shown, SR packet 310 (e.g. SRv6 packet) includes a SR encapsulating header 350 and native packet 340. SR encapsulating header 350 includes an IPv6 header 320 and one or more SR headers (SRHs) 330.

The present technology optimizes both the policy decisions as well as path decisions undertaken when a network assesses communication pathways.

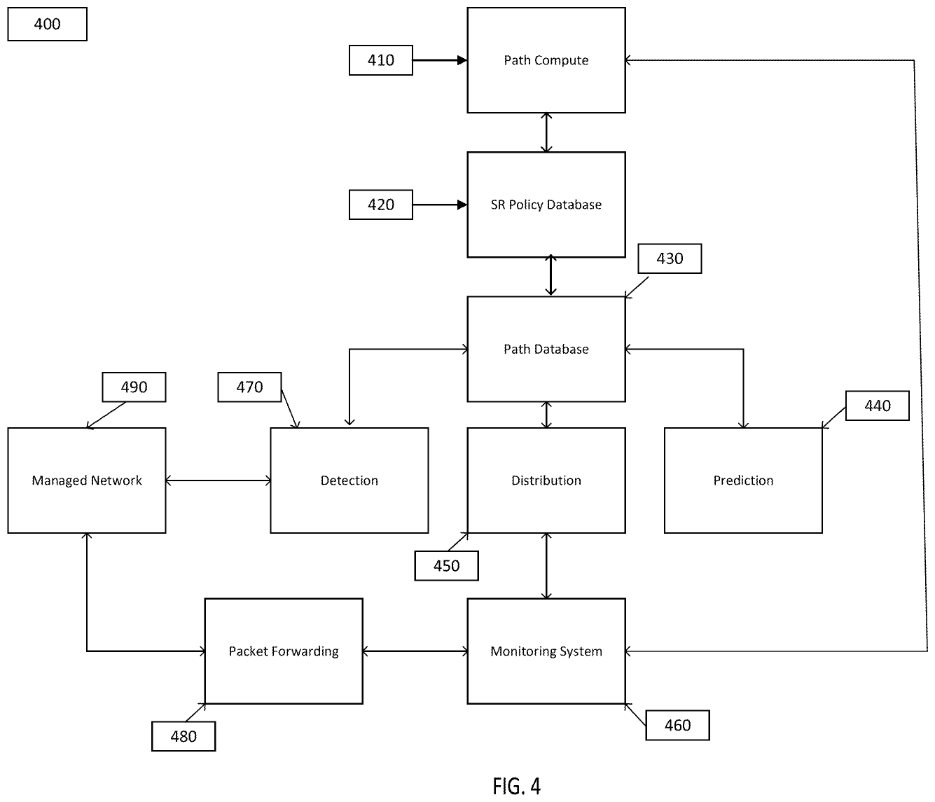

FIG. 4 illustrates an example system 400, which can be used to facilitate the process described herein. The system 400 for example can include any computing device making up a communications system that allows for the identification of unique paths in a network or any component thereof in which the components of the system are in communication with each other using via physical connection via a bus, or a direct connection into the processor, such as in a chipset architecture, a virtual connection, networked connection, or logical connection.

FIG. 4 shows an overall system for the reduction of paths computed by the system for the transmission of packets between a source and destination. When the system 400 is used the number of total paths in the SR policy database 420 that are considered for transmission within the managed network 490 is reduced to the unique paths available in the path database 430. This reduction in paths is because without the unique paths in the path database 430, the SR policy database independently uses paths based on each policy, so different policies can end up using the same paths, that are not actually unique, as they were computed and used for a different policy. By reducing this overlap the system is able to conserve resources, both bandwidth and processing resources, by tracking and determining the efficacy of using only unique paths.

Exemplary system 400 includes path compute apparatus 410. Path compute apparatus 410 is a module within a router that determines what, if any, policies are needed to be installed and used by the system 400. Once path compute apparatus 410 determines what policies are applicable to the transmissions under consideration, the path compute apparatus 410 will build the segment routing (SR) policy database 420, that is used to apply the policies to potential packet transmissions. Furthermore, path compute apparatus 410 can receive information from the monitoring system 460 to determine the status and health of various paths available for transmission, which are used to inform the paths computed by path compute apparatus 410 and included with the policies in the SR policy database 420, which informs the paths in the path database 430.

Exemplary system 400 includes SR policy database 420. SR policy database 420 is optimized based on metrics in addition to standard Interior Gateway Protocol (IGP) metrics. While IGP metrics are traditionally designed for traffic engineering so as to facilitate communication and route information exchange between routers within the same network, additional metrics are needed to fully develop the SR policy database 420. In addition to routing information protocols, shortest path protocols, and enhanced IGP protocols, the SR policy database also accounts for delay metrics within the paths and uses the protocols, including delay measurements, to determine the best paths available for traffic. The SR policy database 420 determines the best available paths for traffic so that traffic is not pushed onto paths that have e.g., backhauling or paths that are e.g., dropping traffic.

The metrics for each path considered by the SR policy database 420 are determined through the use of a path probe, that is sent for each path and returns appropriate metrics that can be used by the SR policy database 420 to determine which paths are appropriate for use in data transmission. Because each policy needs a measurement from each path to determine the appropriate paths that meet the policy rules, the number of path probes increases with the number of paths under consideration, even if multiple policies end up using the same path. These probes, e.g., probe message 110 of FIG. 1, can be sent at regular intervals, based on detected changes in the network or nodes, based on new paths, or updating known paths, amongst other reasons.

Exemplary system 400 includes a path database 430. Path database 430 helps solve the above problem of the number of paths increasing with each policy, even when those paths have already been considered by a different policy. The path database 430 identifies and stores unique paths that are available for transmission between a starting point and an endpoint. The path database 430 stores a history of paths that have been identified by the SR policy database 420, so that whenever a new path is identified by the SR policy database 420, it is checked against the paths already stored within the database. The path database 430 includes the unique paths computed from the SR policy database and may also include other paths to endpoints such as e.g., IGP shortest paths for various algorithms. If the identified path is already stored in path database 430, then it is not unique and the identified path is not stored a second time. If the identified path is new and not in the path database 430, then the path database 430 will identify and store the new unique path.

The path database 430 will also store the history of each unique path within the database. This allows the system to identify if a path has been providing consistently favorable transmission metrics or if the path has been failing at properly transmitting the packets as requested. If the path is consistently able to transmit packets at favorable metrics then that path can be identified as a preferable route for policies to choose for transmission. If the path has consistently failed to transmit the packets as requested, then the path can be identified as a path to avoid unless it is the only path or until updated metric information is collected that shows the failures have subsided.

Exemplary system 400 includes detection apparatus 470. Detection apparatus 470 is capable of sending path probes to or using inline monitoring with the managed network 490, to measure the health of each unique path and provide metrics back to the path database 430. The detection apparatus 470 measures and computes health scores and performance metrics of each path under consideration for transmission, the performance metrics can include the health scores. The measurements for health scores and performance metrics can happen dynamically as probes are sent and received and new information is gathered regarding each path. When new measurements are received, the detection apparatus 470 can undertake new calculations and provide new health scores and/or performance metrics to the path database 430. For example, the health scores and/or performance metrics for a path can include a measure of delay or latency in the path, number of packets dropped, bandwidth available, signal strength, signal-to-noise ratio, bit error rate, jitter, round-trip time, etc. The path probes are transmitted using various protocols, including TWAMP and RFC6374.

The present disclosure can use RFC 6374, which defines a framework for measuring packet loss and delay in Multiprotocol Label Switching (MPLS) networks. The primary purpose of RFC 6374 is to provide guidelines and methods for monitoring the performance of MPLS networks, specifically focusing on measuring the quality of service (QoS) parameters such as packet loss and delay. RFC 6374 provides guidance on selecting appropriate measurement points within the network and the use of various protocols and tools for conducting measurements. The protocol also provides for the continuous monitoring of packet loss and delay to ensure the desired QoS in MPLS networks. This monitoring allows network operators to detect and address performance issues promptly, including various use cases for packet loss and delay measurement. RFC 6374 provides guidance and methods for measuring packet loss and delay in MPLS networks, with the aim of maintaining and improving the quality of service in these networks.

The present disclosure can also use RFC 5357, which defines a standardized protocol for conducting network performance measurements in a bi-directional manner. RFC 5357 provides a standardized and flexible method to measure network performance, including metrics like latency, jitter, and packet loss. These measurements allow the system to monitor and troubleshoot network performance. The protocol also introduces the Two-Way Active Measurement Protocol (TWAMP) architecture, which consists of two main components: a Control-Client (TWAMP-Control) and a Measurement-Server (TWAMP-Server). The Control-Client initiates measurement sessions, while the Measurement-Server responds to measurement requests. TWAMP defines a mechanism for setting up and managing measurement sessions. The Control-Client communicates with the Measurement-Server to negotiate session parameters, such as the test duration, interval, and measurement types. TWAMP also defines control and data packets. Control packets are used for session initiation and management, while data packets carry the actual measurement traffic. The protocol is designed to allow for network performance monitoring, Service Level Agreement (SLA) verification, and diagnosing network issues. RFC 5357 defines the Two-Way Active Measurement Protocol (TWAMP), a standardized framework for conducting bi-directional network performance measurements. It provides a structured approach to measuring key performance metrics while addressing security considerations, making it valuable for network administrators and service providers.

Exemplary system 400 includes a prediction apparatus 440. After the detection apparatus 470 returns the performance metrics or health scores of each of the unique paths, those performance metrics or heath scores are stored in the path database 430. The prediction apparatus 440 is then able to use the performance metrics and/or health scores to predict the future performance metrics and/or health scores for each of the unique paths. Those predicted future performance metrics and/or health scores are then stored in the path database 430 for use by the packet forwarding apparatus 480 to forward packets onto the managed network 490.

Exemplary system 400 includes a distribution apparatus 450. The distribution module receives the health scores detected by the probes used by detection apparatus 470 and the predicted future performance metrics and/or health scores from the prediction apparatus 440. The measured health scores along with the predicted performance metrics and health scores are then sent by the distribution apparatus 450 to monitoring system 460. The distribution module can be used in numerous ways, including providing each individual detected health score and/or performance metric to the monitoring system 460, providing all available measured and predicted health scores and/or performance metrics to the monitoring system 460, and providing the predicted health scores and performance metrics to the monitoring system 460, and combinations thereof. There are multiple examples of distribution processes, including SR Path Measured Attribute (TBD) (source, dest, segment list hash) with measured health and an optional segment list. The system can also use an SR Path Predicted Attribute that includes (source, dest, segment list hash) and the predicted health scores along with an optional segment list. Other mechanisms for distributing per path health are equally relevant. The distribution apparatus 450 is able to collect and distribute the performance metrics and health scores collected and calculated by the system.

The monitoring system 460 takes the information collected by distribution apparatus 450 and determines the information to provide to the path compute apparatus 410 and the packet forwarding apparatus 480. The monitoring system 460 accepts the inputs including any of the computed or measured performance metrics and/or health scores, and uses those inputs to identify the best paths available for use in transmitting packets across the managed network 490. The monitoring system 460 is dynamically monitoring for updated performance metrics and/or health scores so that the best available path is updated upon receipt of new information. This dynamic monitoring allows for the system 400 to update path compute apparatus 410 and packet forwarding apparatus 480 so that the most current information is used when determining which paths to use for transmission in the managed network 490.

Exemplary system 400 includes packet forwarding apparatus 480, which uses the identified path from the monitoring system 460 to transmit packets from one endpoint to another endpoint. Endpoints can include computers, servers, network devices, e.g., routers, switches, hubs, amongst others, as well as other end-user and network devices or applications. The packet forwarding apparatus is then able to assess the best route for the packets based on the information from the monitoring system 460 and forward the packets to the managed network 490.

Exemplary system 400 includes managed network 490. Managed network 490 can be any network that transmits data between endpoints. The managed network 490 can be implemented via any known protocol, including operating with the segment routing protocol previously addressed. The managed network 490 receives traffic from the packet forwarding apparatus 480 and carries the traffic to the destination using the path identified by the system 400.

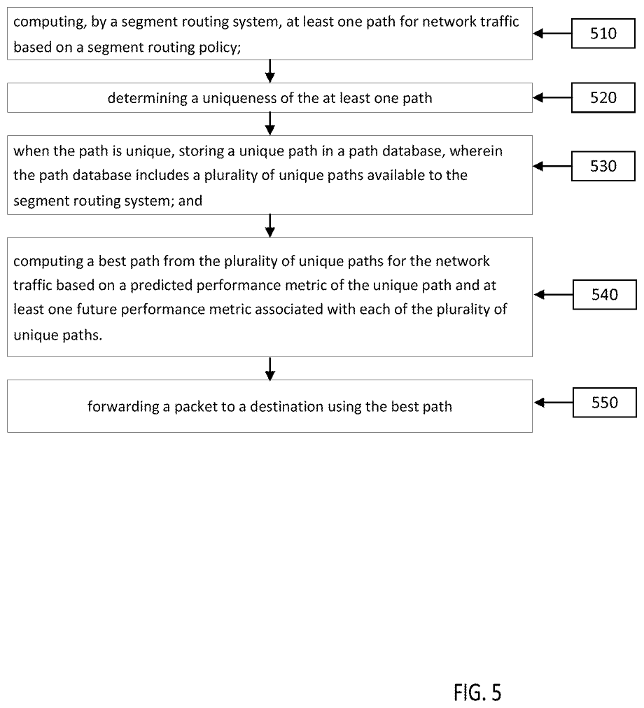

FIG. 5 illustrates a process 500 according to one embodiment of the present disclosure. Process 500 can use the apparatus described with respect to FIG. 4 and exemplary system 400 to identify unique paths and forward traffic to the appropriate destination. To undertake this process, system 400 would initially determine what the destination of the packet and what policies are applicable to the proposed communication. Based on the applicable policies at step 510, the computing, by a segment routing system, at least one path for network traffic based on a segment routing policy. For example, the path compute apparatus 410 and the SR policy database 420, both of FIG. 4, can be used to compute a path for network traffic, that includes feedback from the monitoring system 460, so that the best path(s) that adhere to the policies for that transmission are identified.

According to some examples, the process 500 includes at step 520 that determines the uniqueness of the path(s) identified in step 510. For example, the system 400 can build out a database of paths based on the interactions between the path compute apparatus 410 and the policies stored in SR policy database 420 that are based on the policies stored in SR policy database 420. Based on the path database 430, the system 400 is able to check if the path identified by the path compute apparatus 410 and SR policy database 420 is already in the path database 430. If the identified path is already in the path database 430, then the identified path is not unique. In this example, if a different policy had previously resulted in the identification of the identified path, then the identified path is already in the path database 430, and the path database 430 does not need to store the identified path a second time. By avoiding storing the same path multiple times, this saves the system from having to send probes, track health scores and performance metrics, and make predictions for the health scores and performance metrics, multiple times for the same path. Instead, the system 400 will be able to associate the identified path with a path already in the path database, and then use the information, health scores, performance metrics, probes, amongst others, associated with that path that is already present in the path database 430.

However, if the path database 430 determines that the identified path is not in the path database 430, then the path database 430 will store the identified path in the path database 430, at step 530. This process will allow for each path to only be stored once, so that each path is unique and any measurements, calculations, and predictions only have to be done once for each unique path. The path database 430 will then begin the process of taking measurements, predicting future performance, and storing the results in the path database 430.

For example, the path database 430 will communicate with detection apparatus 470 to send probes into the managed network to measure the performance metrics of the identified path and also calculate a health score for the identified path. This data, e.g., the performance metrics and health score, will be communicated back to the path database 430 where it will be associated with the stored unique path that was probed. The path database 430 will also communicate with prediction apparatus 440, which receives from the path database 430 the measured performance metrics and health scores associated with the stored unique path, and undertakes an analysis of the available data to make a prediction of how the stored unique path will function in the future. For example, the prediction apparatus 440 can determine metrics based on whether the probe is returned or failed to return, the time the probe takes to return, hop counts, device metrics for network devices, flow data, bandwidth utilization, usage metrics, and any other data available to the probe. Using these data, the prediction apparatus 440 can predict the future metrics for the path and how the path metrics may fluctuate.

The prediction apparatus 440 then returns the predicted performance metric and/or predicted health score to the path database 430, where the path database 430 will store and associate the predicted performance metric and/or predicted health score with the unique path. The path database will have access to the available paths, the measured performance metrics, measured health scores, predicted performance metrics, and predicted health scores for each path. Based on the performance metrics and health scores, both measured and predicted, the system 400 can remove the path because it doesn't meet the minimum requirements to be included, the system can prioritize the path because it is performing acceptably, or deprioritize the path from consideration because the path is not performing acceptably. Depending on the system, thresholds for acceptable and minimum performance can be set based on use case and needs of the system. Certain policies may require minimum uptime while other policies may require a minimum throughput, for example. Any measured characteristic important to the transmission can be considered as a threshold or priority by a specific policy.

According to some examples, the process 500 includes at step 540 computing a best path from the plurality of unique paths for the network traffic based on a predicted performance metric of the unique path and at least one predicted performance metric associated with each of the plurality of unique paths. For example, based on the available data associated with each unique path stored in the path database 430, the path database 430 is able to determine the best path based on the policy decisions received from the SR policy database 420. The determination of the best path and the associated performance metrics and health scores, both measured and predicted, are then communicated from the path database 430 to the distribution apparatus 450 which distributes the paths and associated metrics and health scores to the monitoring system 460. The distribution can take place using any appropriate method, including the previously discussed BGP-LS. The monitoring system 460 can then use the best path along with the associated metrics and health scores to influence the path compute apparatus 410 and the packet forwarding apparatus 480. The information collected by the monitoring system 460 can be sent back to the path compute apparatus 410 so that when the next paths are computed the determination uses the most up to date information available to the system, including the performance metrics and health scores available for consideration.

According to some examples, the process 500 includes at step 550 forwarding a packet to a destination using the best path. Based on the best path and associated metrics and health scores, the packet forwarding apparatus 480 can forward the packets to the destination using the best path available on the managed network 490. This transmission will also allow the detection apparatus 470 to further detect the performance metrics and health scores associated with the packet transmission to the destination, which allows for the further iteration and refinement of the available paths to the destination on the managed network 490.

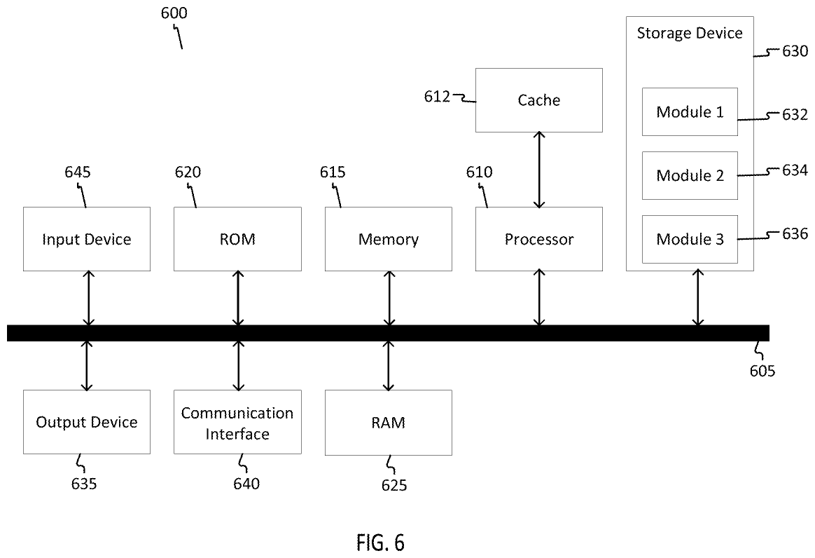

FIG. 6 shows an example of computing system 600, which can be for example any computing device making up system 400 or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments computing system 600 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read only memory (ROM) 620 and random access memory (RAM) 625 to processor 610. Computing system 600 can include a cache of high-speed memory 612 connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. There is no restriction on operating on any particular hardware arrangement and therefore the basic features here may easily be substituted for improved hardware or firmware arrangements as they are developed.

Storage device 630 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

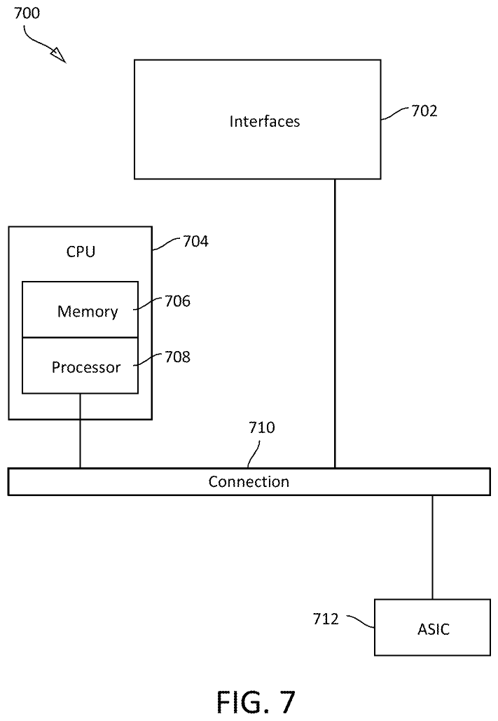

FIG. 7 illustrates an example network device 700 suitable for performing switching, routing, load balancing, and other networking operations. The example network device 700 can be implemented as switches, routers, nodes, metadata servers, load balancers, client devices, and so forth.

Network device 700 includes a central processing unit (CPU) 704, interfaces 702, and a bus 710 (e.g., a PCI bus). When acting under the control of appropriate software or firmware, the CPU 704 is responsible for executing packet management, error detection, and/or routing functions. The CPU 704 preferably accomplishes all these functions under the control of software including an operating system and any appropriate applications software. CPU 704 may include one or more processors 708, such as a processor from the INTEL X86 family of microprocessors. In some cases, processor 708 can be specially designed hardware for controlling the operations of network device 700. In some cases, a memory 706 (e.g., non-volatile RAM, ROM, etc.) also forms part of CPU 704. However, there are many different ways in which memory could be coupled to the system.

The interfaces 702 are typically provided as modular interface cards (sometimes referred to as “line cards”). Generally, they control the sending and receiving of data packets over the network and sometimes support other peripherals used with the network device 700. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communication intensive tasks, these interfaces allow the master CPU (e.g., 704) to efficiently perform routing computations, network diagnostics, security functions, etc.

Although the system shown in FIG. 7 is one specific network device of the present disclosure, it is by no means the only network device architecture on which the present disclosure can be implemented. For example, an architecture having a single processor that handles communications as well as routing computations, etc., is often used. Further, other types of interfaces and media could also be used with the network device 700.

Regardless of the network device's configuration, it may employ one or more memories or memory modules (including memory 706) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 706 could also hold various software containers and virtualized execution environments and data.

The network device 700 can also include an application-specific integrated circuit (ASIC), which can be configured to perform routing and/or switching operations. The ASIC can communicate with other components in the network device 700 via the bus 710, to exchange data and signals and coordinate various types of operations by the network device 700, such as routing, switching, and/or data storage operations, for example.

Aspect 1. A method for measuring unique path decisions, the method comprising: computing, by a segment routing system, at least one path for network traffic based on a segment routing policy; determining a uniqueness of the at least one path; when the at least one path is unique, storing a unique path in a path database, wherein the path database includes a plurality of unique paths available to the segment routing system; and computing a best path from the plurality of unique paths for the network traffic based on a predicted performance metric of the unique path and at least one predicted performance metric associated with each of the plurality of unique paths.

Aspect 2. The method of Aspect 1, further comprising: monitoring a performance metric of the unique path, wherein monitoring takes place using a path probe; based on the path probe, determining the performance metric; storing the performance metric of the unique path in the path database; and based on the performance metric, predicting a second predicted performance metric of the unique path.

Aspect 3. The method of any of Aspects 1 to 2, further comprising: storing the second predicted performance metric in the path database; and associating the second predicted performance metric with the unique path.

Aspect 4. The method of any of Aspects 1 to 3 further comprising: computing a best path from the plurality of unique paths for the network traffic based on the v performance metric of the unique path and the at least one predicted performance metric associated with each of the plurality of unique paths.

Aspect 5. The method of any of Aspects 1 to 4, wherein the second predicted performance metric is a health score associated with the unique path.

Aspect 6. The method of any of Aspects 1 to 5, further comprising: detecting a change in the performance metric of the unique path; and updating the predicted performance metric of the unique path based on the change in the performance metric.

Aspect 7. The method of any of Aspects 1 to 6, further comprising: when the unique path is not unique, determining that the at least one path is a first unique path from the plurality of unique paths in the path database; and computing the best path for network traffic for the first unique path based on a first predicted performance metric stored in the path database and associated with the first unique path.

Aspect 8. The method of any of Aspects 1 to 7, further comprising: forwarding a packet to a destination using the best path.

Aspect 9. A system comprising: at least one processor; and at least one computer readable medium storing instructions, wherein when executed by the at least one processor, the instructions are effective cause the system to: compute, by a segment routing system, at least one path for network traffic based on a segment routing policy; determine a uniqueness of the at least one path; when the at least one path is unique, store a unique path in a path database, wherein the path database includes a plurality of unique paths available to the segment routing system; and compute a best path from the plurality of unique paths for the network traffic based on a predicted performance metric of the unique path and at least one predicted performance metric associated with each of the plurality of unique paths.

Aspect 10. The system of Aspect 9, wherein the instructions further cause the system to: monitor a performance metric of the unique path, wherein monitoring takes place using a path probe; based on the path probe, determine the performance metric; store the performance metric of the unique path in the path database; and based on the performance metric, predict a second predicted performance metric of the unique path.

Aspect 11. The system of any of Aspects 9 to 10, wherein the instructions further cause the system to: store the second predicted performance metric in the path database; and associate the second predicted performance metric with the unique path.

Aspect 12. The system of any of Aspects 9 to 11, wherein the instructions further cause the system to: compute the best path from the plurality of unique paths for the network traffic based on the second predicted performance metric of the unique path and the at least one predicted performance metric associated with each of the plurality of unique paths.

Aspect 13. The system of any of Aspects 9 to 12, wherein the second predicted performance metric is a health score associated with the unique path.

Aspect 14. The system of any of Aspects 9 to 13, wherein the instructions further cause the system to: when the at least one path is not unique, determine that the at least one path is a first unique path from the plurality of unique paths in the path database; and compute the best path for network traffic for the first unique path based on a first second predicted performance metric stored in the path database and associated with the first unique path.

Aspect 15. The system of any of Aspects 9 to 14, wherein the instructions further cause the system to: detect a change in the predicted performance metric of the unique path; and update the predicted performance metric of the unique path based on the change in the predicted performance metric.

Aspect 16. A non-transitory computer readable medium comprising instructions, the instructions, when executed by a computing system, cause the computing system to: compute, by a segment routing system, at least one path for network traffic based on a segment routing policy; determine a uniqueness of the at least one path; when the at least one path is unique, store a unique path in a path database, wherein the path database includes a plurality of unique paths available to the segment routing system; and compute a best path from the plurality of unique paths for the network traffic based on a second predicted performance metric of the unique path and at least one predicted performance metric associated with each of the plurality of unique paths.

Aspect 17. The non-transitory computer readable medium of Aspect 16, wherein the instructions further cause the computing system to: monitor a performance metric of the unique path, wherein monitoring takes place using a path probe; based on the path probe, determine the performance metric; store the performance metric of the unique path in the path database; and based on the performance metric, predict the second predicted performance metric of the unique path.

Aspect 18. The non-transitory computer readable medium of any of Aspects 16 to 17, wherein the instructions further cause the computing system to: compute the best path from the plurality of unique paths for the network traffic based on the second predicted performance metric of the unique path and the at least one predicted performance metric associated with each of the plurality of unique paths.

Aspect 19. The non-transitory computer readable medium of any of Aspects 16 to 18, wherein the instructions further cause the computing system to: store the second predicted performance metric in the path database; and associate the second predicted performance metric with the unique path.

Aspect 20. The non-transitory computer readable medium of any of Aspects 16 to 19, wherein the instructions further cause the computing system to: detect a change in the at least one predicted performance metric of the unique path; and update the at least one predicted performance metric of the unique path based on the change in the at least one predicted performance metric.

What is claimed is:

1. A method for measuring unique path decisions, the method comprising:
computing, by a segment routing system, at least one path for network traffic based on a segment routing policy;
determining a uniqueness of the at least one path;
when the at least one path is unique, storing a unique path in a path database, wherein the path database includes a plurality of unique paths available to the segment routing system; and
computing a best path from the plurality of unique paths for the network traffic based on a predicted performance metric of the unique path and at least one predicted performance metric associated with each of the plurality of unique paths.

2. The method of claim 1, further comprising:
monitoring a measured performance metric of the unique path;
based on the monitoring, determining the measured performance metric;
storing the measured performance metric of the unique path in the path database; and
based at least in part on the measured performance metric, predicting a second predicted performance metric of the unique path.

3. The method of claim 2, further comprising:
storing the second predicted performance metric in the path database; and
associating the second predicted performance metric with the unique path.

4. The method of claim 2 further comprising:
computing a best path from the plurality of unique paths for the network traffic based on the second predicted performance metric of the unique path and the at least one predicted performance metric associated with each of the plurality of unique paths.

5. The method of claim 2,
wherein the second predicted performance metric is a health score associated with the unique path.

6. The method of claim 1, further comprising:
when the unique path is not unique, determining that the at least one path is a first unique path from the plurality of unique paths in the path database; and
computing the best path for network traffic for the first unique path based on a first predicted performance metric stored in the path database and associated with the first unique path.

7. The method of claim 2, further comprising:
detecting a change in the measured performance metric of the unique path; and
updating the second predicted performance metric of the unique path based on the change in the measured performance metric.

8. The method of claim 1, further comprising:
forwarding a packet to a destination using the best path.

9. A system comprising:
at least one processor; and
at least one computer readable medium storing instructions, wherein when executed by the at least one processor, the instructions are effective cause the system to:
compute, by a segment routing system, at least one path for network traffic based on a segment routing policy;
determine a uniqueness of the at least one path;
when the at least one path is unique, store a unique path in a path database, wherein the path database includes a plurality of unique paths available to the segment routing system; and
compute a best path from the plurality of unique paths for the network traffic based on a predicted performance metric of the unique path and at least one predicted performance metric associated with each of the plurality of unique paths.

10. The system of claim 9, wherein the instructions further cause the system to:
monitor a measured performance metric of the unique path;
based on the monitoring, determine the measured performance metric;
distribute the measured performance metric and the predicted performance metric to the segment routing system using a border gateway protocol;
store the measured performance metric of the unique path in the path database; and
based at least in part on the measured performance metric, predict a second predicted performance metric of the unique path.

11. The system of claim 10, wherein the instructions further cause the system to:
store the second predicted performance metric in the path database; and
associate the second predicted performance metric with the unique path.

12. The system of claim 10, wherein the instructions further cause the system to:
compute the best path from the plurality of unique paths for the network traffic based on the second predicted performance metric of the unique path and the at least one predicted performance metric associated with each of the plurality of unique paths.

13. The system of claim 12, wherein the second predicted performance metric is a health score associated with the unique path.

14. The system of claim 9, wherein the instructions further cause the system to:
when the at least one path is not unique, determine that the at least one path is a first unique path from the plurality of unique paths in the path database; and
compute the best path for network traffic for the first unique path based on a first predicted performance metric stored in the path database and associated with the first unique path.

15. The system of claim 10, wherein the instructions further cause the system to:
detect a change in the measured performance metric of the unique path; and
update the second predicted performance metric of the unique path based on the change in the measured performance metric.

16. A non-transitory computer readable medium comprising instructions, the instructions, when executed by a computing system, cause the computing system to:
compute, by a segment routing system, at least one path for network traffic based on a segment routing policy;
determine a uniqueness of the at least one path;
when the at least one path is unique, store a unique path in a path database, wherein the path database includes a plurality of unique paths available to the segment routing system; and
compute a best path from the plurality of unique paths for the network traffic based on a predicted performance metric of the unique path and at least one predicted performance metric associated with each of the plurality of unique paths.

17. The non-transitory computer readable medium of claim 16, wherein the instructions further cause the computing system to:
monitor a measured performance metric of the unique path;
based on the monitoring, determine the measured performance metric;
store the measured performance metric of the unique path in the path database; and
based at least in part on the measured performance metric, predict a second predicted performance metric of the unique path.

18. The non-transitory computer readable medium of claim 17, wherein the instructions further cause the computing system to:
store the second predicted performance metric in the path database; and
associate the second predicted performance metric with the unique path.

19. The non-transitory computer readable medium of claim 17, wherein the instructions further cause the computing system to:
compute the best path from the plurality of unique paths for the network traffic based on the second predicted performance metric of the unique path and the at least one predicted performance metric associated with each of the plurality of unique paths.

20. The non-transitory computer readable medium of claim 16, wherein the instructions further cause the computing system to:
detect a change in the at least one predicted performance metric of the unique path based on a measured performance metric; and
update the at least one predicted performance metric of the unique path based on the change in the measured performance metric.
